(19) United States
(12) Patent Application Publication
(10) Pub. No.: US 2009/0132490 A1
(43) Pub. Date: May 21, 2009

(54) METHOD AND APPARATUS FOR STORING AND DISTRIBUTING ELECTRONIC MAIL

(75) Inventor: Henry Okraglik, Victoria (AU)

Correspondence Address: KNOBBE MARTENS OLSON & BEAR LLP, 2040 MAIN STREET, FOURTEENTH FLOOR, IRVINE, CA, 92614, US

(73) Assignee: CoolRock Software Pty.Ltd., Melbourne (AU)

(21) Appl. No.: 12/095,117

(22) PCT Filed: Nov. 29, 2006
(86) PCT No.: PCT/AU2006/001796

§ 371 Date: Nov. 5, 2008

(30) Foreign Application Priority Data
Nov. 29, 2005 (AU) 2005906663

(51) Int. Cl. G06F 17/30

(52) U.S. Cl. 707/3; 707/100; 707/E17.108; 707/E17.045

(57) ABSTRACT

The present invention relates to a method and apparatus for storing and distributing emails. Instead of using the conventional “Inbox” paradigm, all email processed in an organisation is stored in a database. User access to the emails in the database is carried out by utilising search queries based on a high level language, to search the database.

### FIELD OF THE INVENTION

The present invention relates to a method and apparatus for storing and distributing email.

### BACKGROUND OF THE INVENTION

Note that in this document the terms “electronic mail” and “email” are used synonymously.

Today, email is ubiquitous and is an integral part of a communications platform for any organisation, for handling both internal and external correspondence.

A usual architecture for handling an organisation's email includes an email server (comprising one or more server computers running appropriate software) which is arranged to provide an email communications hub for a plurality of user clients (provided by user computing devices e.g. desktop PCs, programmed with appropriate software). The email server receives email communications from outside the organisation over communication media such as the Internet, and also receives internal email communications between users within the organisation. Email communications are routed appropriately by the email server either externally (e.g. via a gateway to the Internet) or internally to the organisation's user clients.

Conventionally, email systems organise and distribute email according to the “folder” paradigm. Received email (whether received internally or externally) is allocated to a particular folder (allocation usually occurring by the email server). Commonly, every user client will have an “In-box” folder to which all received email which hasn't yet been viewed by the user will be allocated. A user is then able to view all the email that has arrived in their In-box. Other folders are commonly provided. A “Sent items” folder is provided for each user in which items of email are allocated which have been sent by the user, a “Deleted items” folder is provided for a user to access items that they have recently deleted, etc. Further folders may be set up by system administrators, such as common “group” folders in which all email directed to a particular allocated group (e.g. “administration”) within a firm will be allocated.

There are minor variations in the architecture of email systems, but generally the folder paradigm is consistently used.

The volume and importance of email being handled by individuals is now at a level that for many employees their job productivity and efficiency can be directly linked to how effective they are at managing their In-box for each day. A common problem is that too much email may be received by a user in their In box folder for them to efficiently handle.

Another problem is that generally any email addressed to a user will be either directly or indirectly (i.e. by being named in the cc or bcc components of the email distribution) allocated to the user by the email system. This results in many unnecessary emails being allocated to the user and therefore having to be dealt with by the user. A major example of this is “spam”. Where filters and firewalls have been devised to combat unwanted emails which may contain viruses or spam, these processes are by no means perfect (much unwanted email still gets through to users even with security precautions and spam filters) and requires resources for administration.

Another consideration that the present applicants have appreciated, is that the information communicated via email is an important organisational resource which is not presently well-managed. For example, any email that passes through a user's In-box may well include useful information that may be important to access at some time in the future. It is hard to empirically judge if any given email will be useful for reference in the future. Because a user needs to delete emails, emails that may be useful for information for other users at some stage are often not easily available to those users. Archive systems are utilised for archiving deleted emails. Archives are generally accessible by the system administrator, and usually store email in a fashion which makes it quite difficult to locate a particular email without a laborious search.

General users of an email system (eg the user clients) are unable to access the email archives (except via the system administrator) in any event. The potential information resource that should be available to an organisation from their emails is therefore substantially untapped. Users are generally limited to accessing their own emails, and then only those emails that haven't yet been permanently deleted out of their user client folders.

Another issue to be addressed by email systems is the requirement of legislators in many countries for greater accountability from business, requiring companies to keep thorough records for, for example, future audits. An example of this requirement is the Sarbanes-Oxley Act in the United States. An outcome of this Act is that e-mail documentation must be kept and accounted for. Email documentation generally, therefore, should be kept for a number of years and should be easily accessible and searchable in case of audit.

### SUMMARY OF THE INVENTION

In accordance with a first aspect, the present invention provides a method of storing and distributing emails in an organisation having a plurality of email users, including the steps of storing received emails in a database and distributing emails to users in response to a step of querying of the database, by search queries associated with the users.

An advantage of an embodiment of this invention is that access to the emails may be user driven. Instead of emails being allocated to a user by an email system (with limited user control) the user instead queries the database to receive the emails. Advantageously, different queries can be devised and the user may obtain emails from across the database without being limited by any particular folder allocation.

In an embodiment, the step of querying the database is carried out utilising a database query language. Queries may be saved so that they can be re-used and may be shared between users. One or more pre-defined queries may be provided for use by a user. Further, means may be provided enabling email users to formulate their own queries.

In an embodiment, a query may select from all emails available in the database, regardless of the identity of the sender or identity of intended recipient.

In an embodiment, where the step of querying the database is carried out utilising a database query language, the queries may be combined to result in different queries. For example, queries may be combined in AND/OR/NOT style relationships to drill-down or widen a query.

In an embodiment, queries may be utilised to define user access to the emails and the database. They may be used to define user viewable boundaries for the email database. For example, each user may have a “Master Query” that defines the boundary of email they can see. Any query they create is automatically AND'ed with this query to enforce security/boundaries.

An advantage of at least an embodiment of the invention is that it avoids the folder paradigm. In this embodiment emails are not allocated in accordance with pre-defined folders. Instead they are stored in the database and are queried in accordance with queries preferably prepared in a query language (which queries may be pre-defined or user defined). This has the further advantage that the entire “knowledge” stored in an email database is accessible by any user at any time, only being limited by the user query. In an embodiment, security parameters may be provided to limit access to the database in dependence on pre-determined criteria eg security level of a user.

In an embodiment, the step of storing emails includes a step of “normalising” the emails and storing email information in a relational form. In an embodiment, email content is stored in one location and query index information based on the normalisation of the email is stored in another location.

In one embodiment, the method includes the further step of distributing emails to users by allocating the emails to folders. This has the advantage of combining the familiar folder paradigm with the new “query paradigm”. An email user may therefore still have an In-box, but also a query or queries available to them to query the email database.

The step of distributing emails may include the step of distributing email summary information, such as, for example, information from the email subject header or other information from the email. The term “distributing emails” also covers distribution of this email information.

In an embodiment, email summary information comprises an email unique identifier plus its header meta-data (including but not limited to things like Subject, Sent Date, Received Date, From, To, CC, Size, etc). This is similar to how the email clients currently work. That is, they retrieve all the headers to display in tabular format in an in-box. As the header is clicked then the email content is received.

In accordance with a second aspect, the present invention provides a method of storing email received by an organisation, including the step of storing the email in relational form.

In an embodiment, the step of storing the email in relational form includes the step of processing the emails to provide an index, the index being stored in relational form. In an embodiment, the index is stored separately from the email content.

In an embodiment, the email database is used to archive an organisation's email.

In an embodiment, the step of storing is carried out by a storage management engine process, which is arranged to interface with an underlying database architecture. In an embodiment, the storage management engine process is able to interface with different types of database architecture, and may use a “plug-in” approach to achieve the interface. The storage management engine process presents a single process to the “front end”, however, regardless of the back-end database architecture utilised. Queries of the database therefore only need to interface with the storage management process. The storage management process is essentially unconcerned with the technical details of the databases/file systems/storage devices being used in the underlying database structure and therefore presents a “virtual storage architecture” to the front-end. The single storage management process may span different database architectures and different databases, providing a single “front end” with access to all.

In accordance with a third aspect, the present invention provides an apparatus for storing and distributing email in an organisation having a plurality of email users, the apparatus including a database arranged to receive emails and a distribution means arranged to distribute emails to the email users in response to search queries to the database, the search queries being associated with the email users.

In accordance with a fourth aspect, the present invention provides an apparatus for storing email received by an organisation, including a relational database arranged to store the emails in relational form.

In accordance with a fifth aspect, the present invention provides a computer program including instructions to control a computing system to implement a method in accordance with the first aspect of the invention.

In accordance with a sixth aspect, the present invention provides a computer readable medium providing a computer program in accordance with the fifth aspect.

In accordance with a seventh aspect, the present invention provides a computer program including instructions for controlling a computing system to implement a method in accordance with the second aspect of the invention.

In accordance with an eight aspect, the present invention provides a computer readable medium providing a computer program in accordance with the seventh aspect of the invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a diagram illustrating a conventional email system;

FIG. 2 is a schematic diagram of an email system incorporating an apparatus in accordance with an embodiment of the present invention;

FIG. 3 is a diagram illustrating a more detailed architecture of a server component of the apparatus of FIG. 2;

FIG. 4 is a diagram illustrating how email information may be organised in a relational way in accordance with an embodiment of the present invention;

FIG. 5 is a further diagram illustrating relational organisation of email information;

FIG. 6 is a representation of an example graphical user interface (GUI) that may be utilised by an apparatus in accordance with an embodiment of the present invention;

FIG. 7 is a diagram illustrating a more detailed architecture of a storage management engine component of the apparatus illustrated in FIG. 3;

FIG. 8 is a diagram illustrating an organisation of the storage means of the apparatus of FIG. 3;

FIG. 9 is a diagram of an alternative embodiment of an apparatus in accordance with the present invention; and

FIG. 10 is a diagrammatic representation of a GUI for an example application of an embodiment of the present invention.

### DETAILED DESCRIPTION OF EMBODIMENTS

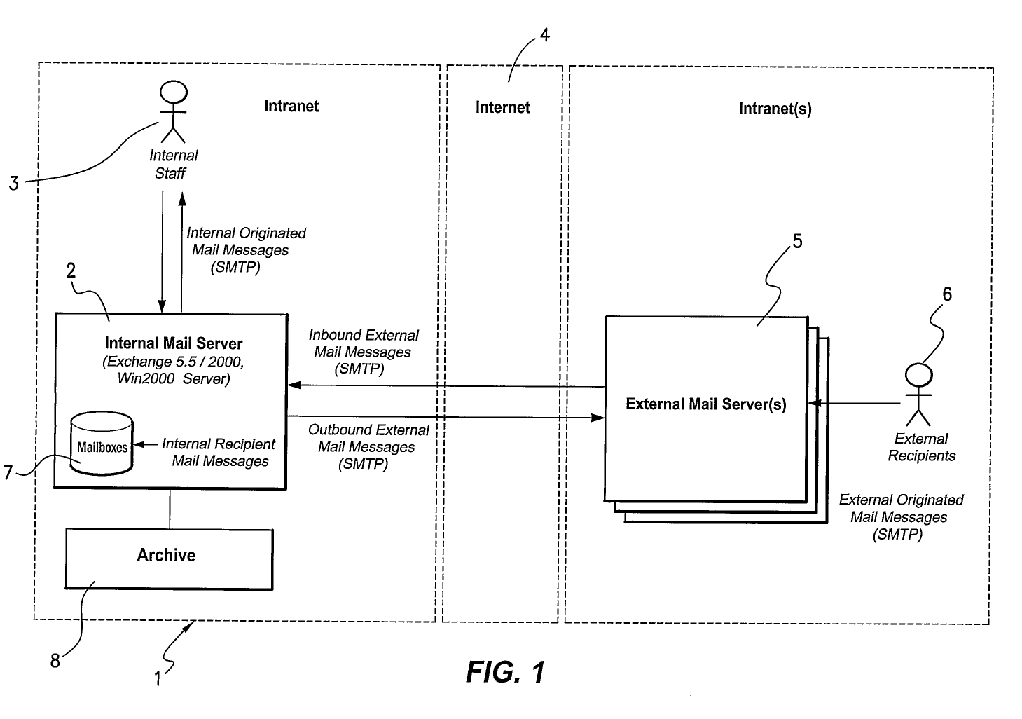

FIG. 1 is a schematic diagram of a conventional-type email system. An organisation's email system, generally designated by reference numeral 1, includes an internal email server 2 which acts as a communications hub for email for an organisation's intranet, represented by the symbol reference numeral 3. The Intranet 3 may incorporate user client devices including any conventional hardware and software such as, for example, a number of desktop PCs with the appropriate client software for receiving and displaying email served by mail server 2 and also for formulating and sending emails to mail server 2. The conventional email system 1 utilises Simple Mail Transfer Protocol (SMPT). The mail traffic encompasses:
Mail sent from internal mail accounts to other internal recipients.
Mail sent from internal mail accounts to external recipients.
Mail sent from external entities to internal recipients.

Mail sent to and received externally from the organisation will usually be routed via a gateway (not shown) and communications media such as the Internet 4. Communications will eventually be with various mail servers 5 and external recipients 6.

Some organisations may have more complex set ups, involving multiple internal mail servers and often separate servers to handle internal and external originated mail traffic. The general principal, however, is consistent.

When messages are received by the mail server 2 for internal recipients, the mail messages are allocated to the various mail boxes that have been set up (usually by the system administrator). In FIG. 1 the mail boxes are designated by reference numeral 7. Various email systems handle the distribution of mail differently. Mail may be distributed to the user client device or may remain on the mail server for access by the user client device remotely. Another architecture retains mail on the server but copies mail to the user client device. The folder paradigm, however, is consistently used regardless of the email system architecture.

In the organisation, system 1 also includes an email archive system 8. Conventional archive systems tend to be fairly vendor specific. Some systems copy emails to the archive periodically (and they then may be deleted from the server). Other archives may periodically move emails to the archive system 8. Current archive systems will generally store email in a hierarchical fashion in accordance with a policy. Storage media may include disk and tape. The archive systems are generally quite difficult to search and access is usually only allowed by secure personnel such as system administrators. Access is not generally allowed to general system users i.e. client users 3.

The conventional email system, in particular the folder paradigm, has a number of problems as previously discussed. In particular, because emails are allocated to folders and then archived in difficult to access storage, the organisations information resource which is composed by the emails produced and received is not able to be efficiently utilised or accessed.

It is becoming more and more necessary to be able to access emails as an information resource. To give just a few simple examples:
A customer rings up asking about why they did not have an invoice item refunded on their current bill. They claim to have received an email from another employee (who has since left the organisation) who authorised and acknowledged the refund.
A new employee starts and is made a member of numerous distribution lists to ensure they are made aware of all relevant company memos. However, they have no access to that important memo sent the day before they started informing employees of new important health and safety regulations changes.

In these sorts of situations, email needs to be viewed as an information resource to be managed in much the same way as a customer contact details are managed in a CRM system, or stock inventory in an inventory management system. The ability to access this sort of rich vault of data could provide a variety of clear advantages for organisations, such as:
No “lost” correspondence. When customers or clients ring up, employees can instantly get hold of any relevant email information regarding that client and be guaranteed that the email trail they are viewing forms the complete picture of correspondence between their organisation and that client.
Improved efficiency. With an email information resource, employees do not have to chase around to find out “who said what to whom”. No need to ask their colleagues to forward on correspondence with a customer they are dealing with, or to ask that they be cc'd on important correspondence with customers.

All organisations will have particular storage requirements for all emails sent and received by their organisation, driven by not just operational requirements, but more significantly by legal and commercial requirements.

Emails are rightfully becoming recognised as crucial legal documents in their own right that a company will need access to in the case of dispute resolution with external or internal parties, such as a customer law suit against them, or an employee sexual harassment investigation. In these situations it is essential that:
All electronic correspondence between relevant parties over the relevant period be retrieved. It is particularly important that there be no gaps or missing documents so that the set of email retrieved provides as accurate a picture of the case as possible.
The authenticity of the emails is beyond reasonable dispute. The email management system must be capable of ensuring the authenticity of emails stored to avoid fake messages being sent, or existing messages being altered.
The organisation can demonstrate they have taken due diligence in storing and archiving important legal documents relating to the operation of their business. This may be particularly important in cases such as taxation audits or a customer/client/partner dispute resolution process.

Modern email systems are largely accessed through client side mail management programmes such as Outlook™ and Mozilla Mail™ that can store and manage mail boxes locally. This model has a large impact on desktop maintenance activities, particularly for large organisations. Maintenance of mail box storage limitations is a decentralised process. When staff leave, change locations or even when they receive a desktop upgrade, there are considerable desktop maintenance activities associated with deleting or migrating mailbox data.

A conventional email system, such as disclosed in relation to FIG. 1, does not provide satisfactory access to email as information resource.

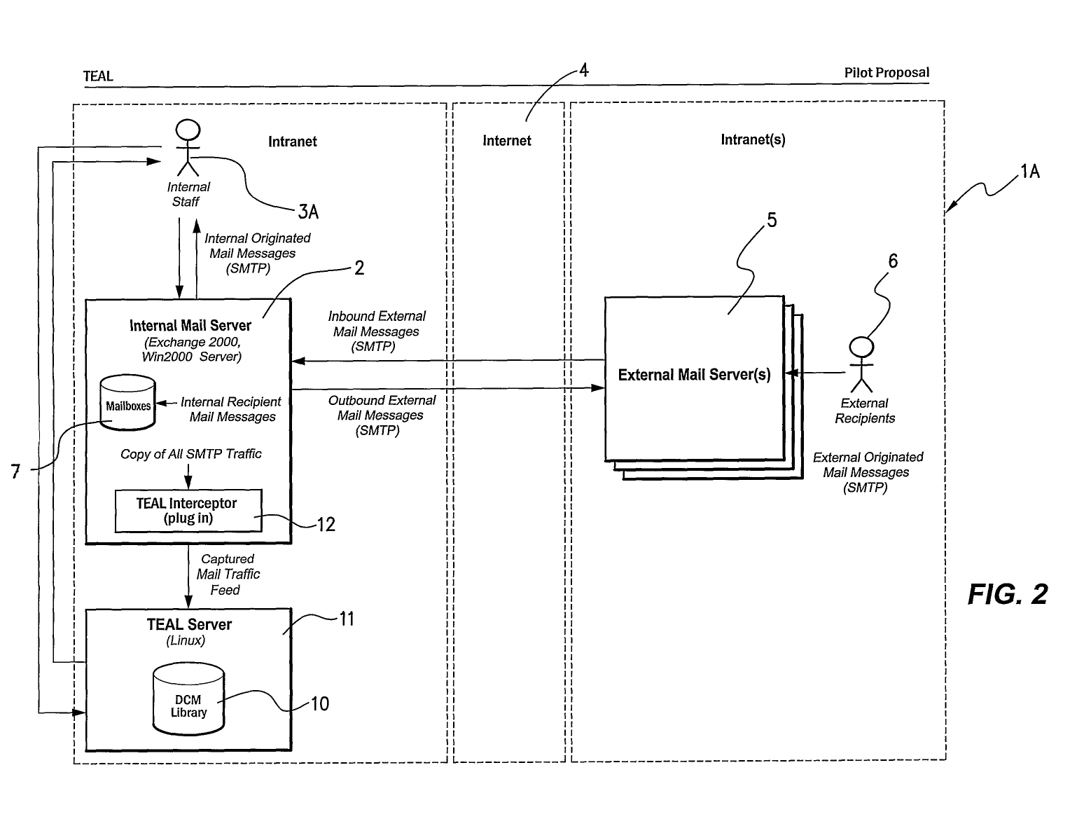

FIG. 2 is a diagram illustrating an overall architecture of an email system incorporating an apparatus in accordance with an embodiment of the present invention.

The system illustrated in FIG. 2 includes some of the same components as the system of FIG. 1, those components have been given the same reference numerals and no further description of the similar components will be given.

The apparatus of this embodiment of the present invention includes a database 10 which is arranged to store emails received (both from the internal intranet 3A and externally). A distribution means, in this example embodiment being in the form of a further server 11, with appropriate software (to be described in more detail later) is provided for distributing emails to users 3A in response to a step of querying the database 10. In this embodiment, user client software is provided for the user devices in order to interface with the server 11 and database 10.

In this embodiment the server 11 is designated a “TEAL” server. TEAL stands for “Transparent Email Archiving Library”.

In more detail, a TEAL interceptor 12 is provided in the form of plug-in software to the internal mail server 2. The interceptor 12 copies all SMTP email traffic and feeds it to the TEAL server 11 where it is queued for processing (see later). Each email is “normalised” to produce query index information which is stored in the database 10 and which is accessible from user clients 3A via queries to obtain the email information and access referenced emails.

The provision of the interceptor 12 enables every single email message in or out of the network 1A to be captured. This is performed in a completely transparent manner from the end users and clients, removing any adverse burden of enforcing any email archiving policy for individual clients. The archiving is done automatically by the interceptor and the TEAL server 11.

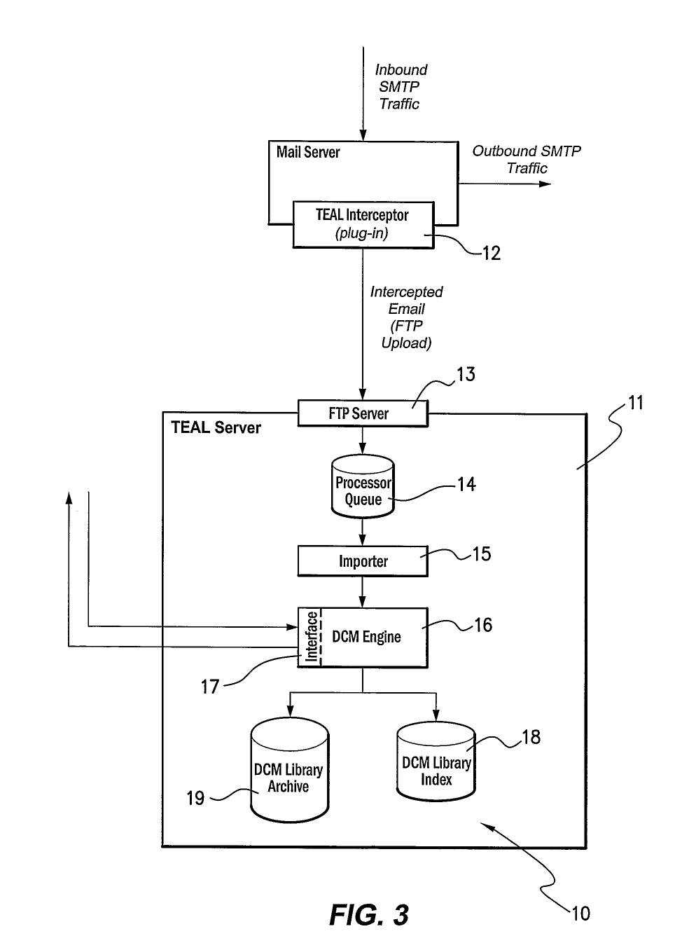

Referring to FIG. 3, in more detail the TEAL server includes an FTP server 13 which is arranged to receive intercepted mail from the TEAL interceptor 12. The upload process to the TEAL server 11 is via an FTP connection to the FTP server 13. As the TEAL interceptor 12 is likely to be intercepting very high volumes of email traffic on the email server, the burden of processing and archiving email is moved off the email server onto the TEAL server 11 at the quickest rate possible. The use of the FTP protocol ensures that the plug-in 12 remains relatively simple to implement. Email messages will be kept in an upload queue at the TEAL interceptor 12 until the FTP upload acknowledges that the email has been received and persisted to local storage 14 on the TEAL server 11. Once they have acknowledged as being uploaded, the email message will be deleted from the upload queue.

If the connection should fail at any stage (i.e. due to a firewall connection timeout setting), then the upload process will attempt to reconnect the TEAL server and re-send any unacknowledged emails along with new emails flowing through the system.

The processor queue 14 or “upload queue” 14 is provided in this embodiment by a fast disc storage and provides a means of quickly storing intercepted email in a queue for subsequent processing. The email is stored as raw email content. This enables the server 11 to keep track of high volumes of emails during peak periods and no email messages are lost, without over loading the email server. The TEAL server 11 is then able to process the emails in the processor queue 14 for storage in the database 10.

An importer processor 15 is provided in server 11 and is arranged to receive emails from the processor queue 14, parse their contents and import into a storage management engine 16. The storage management engine 16 has a number of tasks, which include in this embodiment “normalisation” of the emails and storage in the database 10. The storage management engine 16 also provides an interface 17 for enabling queries by user clients and returning emails and email information to the user clients in response to the queries.

In this embodiment the storage management engine 16 is termed a “digital content management” engine (DCM engine).

The database comprises two sub-databases, in this embodiment being a library index 18 and a library archive 19. The index 18 stores query index information in the form of relationally stored meta-data about the emails. This index is produced by the storage management engine 16 by a process of normalising received emails. The relational index may be queried by utilising query language, obtaining access to the email information stored in the index and also to cross referenced emails stored in the library archive 19. The library archive 19 stores mail message contents in a secure, accessible manner. The library archive 19 utilises a file based storage medium, rather than a relational database medium (as utilised by the library index 18). The library index 18 maintains all the required relationship and indexing information required to perform high performance, complex queries on the contents of the library archive 19.

Note that the archive as well as storing the email message contents, also stores header, body and attachments to the email.

The splitting of the relationship (library index 18) and content information (library archive 19) allows for efficient storage and organisation of the information. The information relevant to the relationships between mail messages, is placed in a relational database to allow for high performance, complex queries to be executed on them, whilst the bulk of the message, the body, which carries much less relational information, is stored on a file-system optimised for high data volume storage.

The emails are processed (as will be discussed below) and stored in the database 10 for future access by users. Emails received by the mail server 2 are therefore captured by the interceptor 12 and then processed the database 10 in real-time. There will obviously be some delay between capturing the emails and processing them to the database 10 where they can be subsequently accessed by the user client 3A. The term “real-time” in this document encompasses this processing delay.

As will be discussed in more detail later, the database 10 may be highly-vendor independent. A company may wish to utilise their own Oracle server infrastructure to host the database 10, for example, and the structure of this embodiment's architecture allows for this.

The database 10 is arranged for storage of what could potentially be a very large volume of data, which may represent every single email sent and received by an organisation's network over several years.

The TEAL server 11 and database 10 are arranged to ensure that:
Every email message placed in the database 10 will be permanently stored until it is explicitly purged by an administration process (after a predefined period of time).
No duplicate messages exist in the database 10. Each stored message will be unique and will represent a real email event that occurred in that organisation. One technique for quickly and efficiently implementing this is to generate an MD5 based on the binary contents of an email message and then use this as the primary key for that message throughout the system.
Retrieval of sets of email messages defined by any combination of possible relationship criteria is processed as quickly as the underlying relational technologies and physical storage technologies allow for.
Access controls ensure that every retrieval request the database receives is from an authenticated end user. Only email messages that end user has been authorised to view (on a per sender/recipient basis for example) will be visible to that user.
All email retrieval requests can be audited to provide authorised administrators with a full trail of which email messages have been accessed by which end users.

A capability of the system is the ability to identify and efficiently manage the many complex inter-relationships between email messages.

### Normalisation

The process of normalisation is used to organise the storage of the email messages into relational structures.

An denormalised, raw view of a set of email messages may be stored in a flat table such as:

| ID | FROM | To | SUBJECT | DATE | PRIORITY |
|---|---|---|---|---|---|
| 1 | reservation@travelagent.com | adam@companyx.com | Your | 270/07/04 | Normal |
| | | | Virgin | 15:09 | |
| | | | Blue | | |
| | | | Itinerary | | |
| | | | for Mr A | | |
| | | | Herring | | |
| 2 | bill@companyx.com | developers@companyx.com | Re: CRC | 27/07/04 | Normal |
| | | | lookup | 14:16 | |
| | | | table | | |
| | | | generation | | |
| 3 | jason@companyx.com | developers@companyx.com | Alarm | 27/07/04 | Normal |
| | | | | 08:30 | |
| 4 | henry@companyx.com | adam@companyx.com | FW: | 26/07/04 | High |
| | | | Strategy | 15:34 | |

This is typically how traditional email systems store email. Identifying relationships within a denormalised structure will typically require a linear scan of the whole table, which would be impractical when dealing with thousands, if not tens of thousands of email messages.

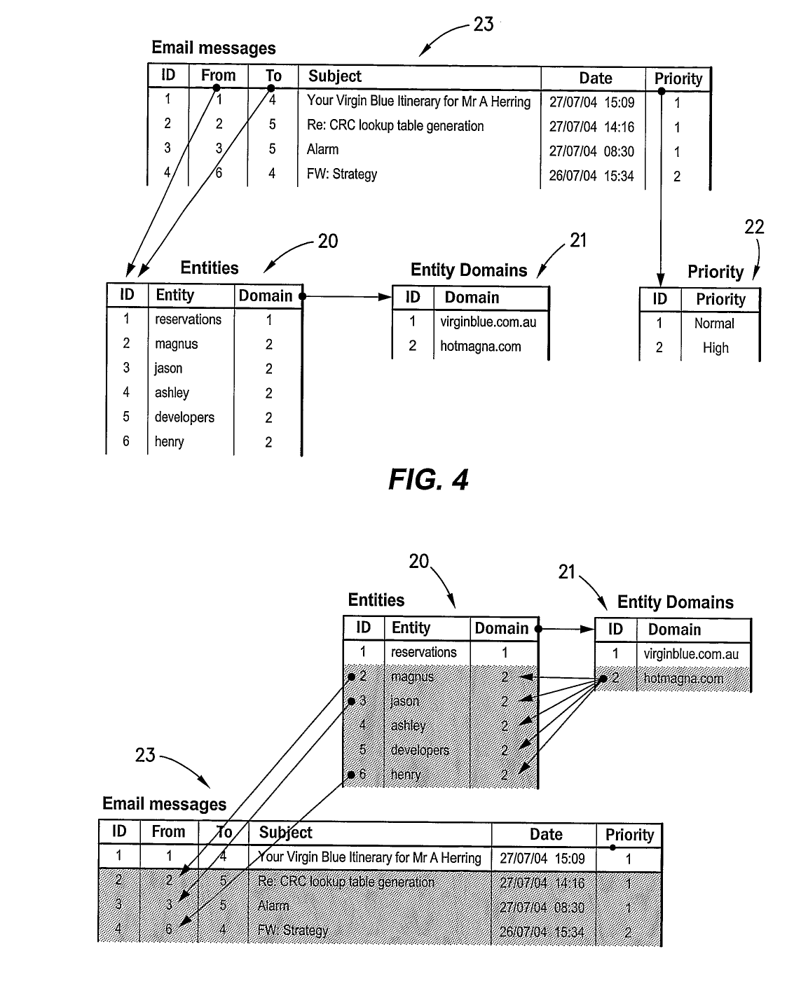

Normalisation is a process of identifying related data within information and using a linking/indexing mechanism to store these relationships with the information itself. In the above example, a normalised view of the email messages may look like the series of relational tables illustrated in FIG. 4.

In this example, the common relationship information such as From, To addresses has been split out into Entity 20 and Entity Domain tables 21, along with information with finite possible values such as Priority 22. The original Email Messages table 23 now stores links rather than the raw information. The information is now normalised.

What advantage does this offer? It provides a very quick, efficient and highly scalable means of cross-referencing data based on these normalised fields using indexes. See also FIG. 5.

### Email Header Inter-Relationships

At a high level, an Email message can be viewed as being comprised of two parts: the Header and the Body. The Header contains a variety of important information that can be used to identify inter-relationships in email streams.

Email Header Information
Email sender
Email recipients (to, cc, bcc)
Reply-To address
Subject
Date
Priority
Message ID/In-Reply-To
References (optional meta-data)
Keywords (optional meta-data)
Comments (optional meta-data)
Implementation specific Extension Fields, such as:
   Original To
   Original Arrival Time
   Accept Language
   Mailer.

By storing this information in a relational form (that is, in a relational database) the following kinds of inter-relationships can be readily identified:
Identify all emails that were exchanged between Company X and Company Y for the month of July 2004.
Identify all emails that were sent from company managers to internal recipients containing “Memo” in the subject in a given week.

Identify all emails containing one or more PDF attachments received from Company Z last year.
Identify, based on volume of sent emails from the payment gateway system containing “Order Receipt” in the subject, the top ten customers that purchased products online. Drill down into totals per month (i.e., in February 2004 we Company X made 112 online purchase, in March 2004 that number was 240, etc).

### Textual Inter-Relationships

Identifying and managing relationships in free text fields, such as Subject field for example, is more complex, as this information is not inherently normalisable. Different emails all with a subject line relating to the same topic can be comprised of a variety of different actual text. For example:
“Memo: Fire Drill this Afternoon”
“memo—there is a fire drill this afternoon”
“ATTENTION: FIRE DRILL TODAY”
“(MEMO)—FIRE DRILL today.”

These four subject text strings all relate to the same topic, yet using a character by character comparison are completely different strings. Standard normalisation techniques therefore will not work for efficiently identifying textual relationships.

However, identifying textual relationships by manually searching every subject string in the Library may be time consuming, so some degree of indexing may be utilised to make the process more efficient.

Full-text indexing and searching engines such as Lucene™, provide an efficient means of building case-insensitive word indexes, so sets of messages containing instances of a given word or combinations of words can easily be identified. Advanced features of these indexing and searching schemes even allow for word proximity searches to be made—i.e. find messages with the word “Apple” occurring within 1-10 words of the word “Orange”.

The challenge lies in picking the right balance of words to index on. Obviously common English words such as “the”, “or”, “and”, “it” and “I” would not be good indexing candidates as almost every single message would be added to the index.

### Email Body Inter-Relationships

In addition to the inter-relationships readily identified through the header information, the actual email body can also be used to identify relationships. For instance, it may be desirable to identify all emails in the database containing the term “Email Relationship Management” somewhere in the body.

Like subject strings discussed above, information in the body is inherently denormalised—and full text-searching indexes on particular important keywords may need to be maintained in some embodiments.

### Encoded Emails and Attachments

Full text search engines are designed to index and search plain text content. Emails however can be encoded in a variety of formats, such as HTML or Rich Text Format and will also include attachments such as PDF, Word documents, Open Office documents etc. Both non plain text content and document attachments should be searchable using the same full text search engine utilised for normal plain text emails.

Our proposed scheme for addressing this issue is to create an Open-API plug-in architecture that the full text search engine in the system could utilise to decode email content and attachments into plain text content for searching and cross-referencing purposes. Plug-ins would then be supplied for decoding PDF, Word, HTML, RTF, winmail.dat documents to ensure their contents could be used in performing full-text searches of the database.

### Encrypted Email

Encryption of email content, performed by mail client software, does pose a problem for Email Relationship Management, as full-text indexing and searching capabilities cannot be utilised to search encrypted content. If encryption of some email is required or mandated, for instance any external email correspondence, then the Email system will apply encryption/decryption at the external firewall boundaries, rather than on mail client software, for a non-encrypted and hence search capable, version of that email to be stored in the database.

In an embodiment of the invention, the following is a list of meta-data which may be mined from email's:
Distribution (from, to bcc, delivered-to, reply-to, cc), Sent and Received times, Subject+Root Subject (root subject is the original subject line that may have been replied to/forwarded etc—used to tract conversations), Topic ID, Priority, Attachments (type, name, size), size, number of words, number of unique words.

In addition to this we may also index the word-email relationships as follows:
for each email we extract a list of unique words in it, subtracting “stop-words”—common words such as “is, a, it” etc. Then we tally up the number of times those unique words appear and for each unique word we add to an index for that word the email ID and the number of times that word appears.

This may be extended to also store the order in which those unique words appear (i.e. “Coolrock” appears as the 3^{rd}, 35^{th}, 70^{th} and 81^{st} word of a given email). This would allow us to then do searches on phrases—i.e. words appearing in a particular order.

### Query Language

Once the emails are stored in the system in the database 10 in relational form (in particular in the index 18), then the system provides an interface 17 by which a query language may be utilised to query the database 10. Queries formulated in the query language are known in this document as “Email Perspectives”.

An Email Perspective is a particular defined “view” of the database based on a set of relationship criteria. In this regard, an Email perspective of the database is analogous to a SQL Query (and its resulting result set) in a RDBMS. Instead of returning generic row data based on relationship criteria, an Email Perspective will contain a set of email messages contained in the database.

An Email Perspective therefore is a reusable and dynamic definition of a particular cross-section of the database, defined by a set of relationship requirement criteria.
Reusable: The Email Perspective can be defined and stored for reuse and shared between different users. Email Perspectives will only show the Email messages defined by that perspective that are accessible by that user. That is, a given Email Perspective definition may show different sets of messages for different users based on what their access rights are.
Dynamic: The Email Perspective will show new messages that fit its relationship requirements as they are added to the Library.
Combinable: Email Perspectives can be combined and nested in AND/OR/NOT style relationships to form new Email Perspectives. For instance an Email Perspective defined to return all Sales staff correspondence can be combined in an AND relationship with an Email Perspective defined to return all internal organisation correspondence to define a new Email Perspective that will result in all internal Sales staff correspondence. This process will greatly simplify the process of defining and managing Email Perspective definitions.
The query language is database agnostic. At a high level it describes an email/centric query tool with no requirement for understanding relational database technologies to use and define the queries. For example, SQL is but one technology used in “compiling” the query language. Other technologies could be used to query the email database, below the high level query language. For instance, we can also use a full-text word indexing engine that is non-SQL based. The query engine may translate and co-ordinate email Perspective queries into both SQL and full-text search queries and process the results. Other “compilation” technologies may be used.
The query language may be used to enforce security and access/rights to emails, by defining user viewable boundaries. That is, each user may have their “master Perspective” that defines the boundary of email they can and every Perspective they create is automatically AND'ed with this Perspective to enforce rights.

Traditional mailbox systems use the ubiquitous Folder metaphor to manage Email relationships—i.e. new mail is in the In-box folder, sent mail is the sent folder, work mail gets filed under the Work folder etc.

Email Perspectives offer a number of clear advantages over the traditional folder based approach for the end user mail management experience:

### Automatic Email Management

As Email Perspectives are fully dynamic ways of obtaining a subset of the Email Library, to the end user they represent an automatic email management mechanism. In contrast to folders, no effort on behalf of the user is required to “move” or “file” an email in a target perspective.

Some folder based email systems attempt to mitigate the problem of manual email folder management through the mechanism of filter definitions and automatic execution of the filters on the In-box to move inbound mail to target folders.

Putting the other advantages listed here aside, Email perspectives are similar to Email Filters in this regard, with two key differences—Email Perspectives can be defined and applied retrospectively at any stage to emails in the Library, not just those in the In box, plus they permit a single email to exist across multiple views simultaneously (see below).

### Efficient Email Management

Email Perspectives can be set up once, stored and reused across any number of users. Importantly this allows for a central Library of predefined perspectives that return results relevant (and access controlled) for a given end user of that perspective. Contrast this with the current complex manual configuration of folders and filters in modern email systems that have to be performed on a per-client basis.

Email Perspectives provide the end-user with a set of predefined “views” into the corporate email pool, allowing them to monitor sets of email traffic relevant to particular tasks without being cluttered by email not relevant to that task.

For example, an end user may set up separate Email Perspectives to monitor communications from fellow Developers, another perspective to monitor bug reports from external customers sent to any of the developers, plus a separate perspective to monitor emails from their friends regarding social arrangements. Email Perspectives provide an efficient way to automatically separate out these emails into different logical views, including emails from multiple mailboxes. No manual folder filing is required and there is no need to hit the delete key!

### Multi-Email Views

Email messages and Email Perspectives have a 1:many relationship. A given email message can be apart of any number of perspectives, unlike traditional folders which mandate that an email message must belong to one and only one folder.

This 1:1 relationship of folders is particularly limiting when trying to organise email on different criteria, for example if you want to keep track of both all work emails and work emails relating to a particular topic separately.

### Multi-Mailbox Views

Email perspectives match email messages across the entire database 10, not just a single email account. Backed up by the system security and access mechanisms, they provide an easy and secure way to share email, communications within subsets of an organisation.

Some folder based email systems use the concept of shared folders to allow email to be shared across multiple accounts, but these cannot be applied retrospectively or in a manner that allows email to be stored in multiple folders like Email Perspectives.

An alternative approach to shared folders has been the use of distribution lists, usually cc'd on an email message to ensure all members of that group receive a record of the correspondence. For example, the Sales Group may have a sales@comanyx.com distribution list that all sales correspondence to external customers is bcc'd to. Sales staff may combine this with a filter rule to place sales@comanyx.com email they receive into a special folder. Email Perspectives provides a supplementary mechanism for this that solves the following problems inherent of this approach:
Email Perspectives are fully retrospective. If a new Sales member joins, the “Sales Perspective” allows them access to every sales correspondence in the database 10. In contrast the distribution list approach only allows that new Sales staff to receive sales correspondence sent after they started.
Email Perspectives do not require the sender or receiver remember to cc or bcc in any distribution list to capture email. As the system captures all email sent or received in the organisation and Email Perspectives show information stored in the database 10, this is fully automatic and able to capture every relevant email.

In this embodiment, the Email Perspective query language is a language that sits over SQL. As an example: let's say that I want to query all emails sent from a person called Adam to a person called John at a organisation called Companyx.

The SQL might look something like this:

select * from messages where

from=(select entityId from entities where address=“adam@companyx.com”)

and

to=(select entityId from entities where address=“john@companyx.com”);

The SQL will also be very specific to the database technology being used and is not particularly readable or intuitive to the average end user as to what task it performs.

Email Perspectives, whilst being primarily UI driven, might be defined as something like:

Perspective (“From Adam to John”) is:

from=adam@companyx.com

to=john@companyx.com

The difference here is we are defining a higher level abstraction that is very specific to the user domain—that is defining email search criteria. The database specifics, such as table names, column names, joining statements, etc. are all hidden from the end user, allowing for a more intuitive query interface specifically customised to email and independent of the actual database technology being used.

The Perspective query language can sit over any database query language or full-text search query, as discussed above. It is not limited to SQL. It is a high level, intuitive language that can be used to interact with many different database architectures and searching processes.

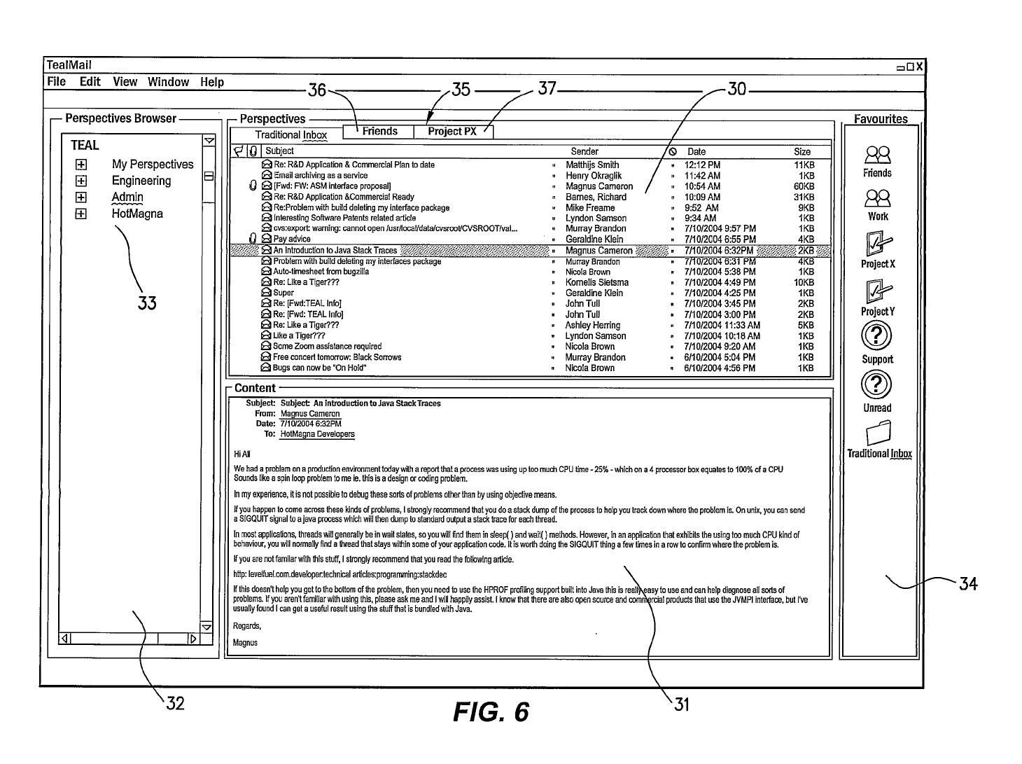

FIG. 6 is an example of a graphical user interface (GUT) that may be provided by the apparatus of the present invention, in the form of user client software on a user client device.

The view of the Perspective is much like the view of a folder, in the way items are displayed as a table of email header information and a split pane showing the content of the selected email. In FIG. 6, it is actually the “traditional” In-box which is shown open with the split pane showing the header in one pane 30 and the email content in the other pane 31. One advantage of this GUI is that the traditional In-box where emails are allocated by the email server 2 is combined with the queries of the TEAL server 11 and database 10 in the form of Perspectives. In other embodiments, the traditional In-box may be done away with and only Perspectives utilised to query the TEAL server 11 and database 10.

Referring again to FIG. 6, on the left hand side “Perspective Browser” 32 allows access to saved Perspectives 33, including those that may be pre-defined and shared across the company. Some of the Perspectives will be Read-only for the average employee (i.e. they could not re-define what “Admin” was). On the right, “Favourites” can be saved 34. People will quickly work out which Perspectives are of the most use of them and set up short cut links in the Favourites Section 34.

Perspectives may also be “Tabbed” 35. Like Mozilla™ with its tabbed web pages, the GUI client of the present apparatus also shows Email Perspectives currently opened in separate Tabs (“Friends” 36 and “Project PX” 37 in this example).

It will be appreciated that this GUI is merely one example embodiment only, and many variations could be implemented.

### Combining Perspectives

Perspectives can be combined to provide views that are unions (OR relationships) or intersections (AND relationships) of those views. To give an example, let's say we had a set of simple perspectives defined:
A. All Emails in the last 10 minutes
B. All Emails in the last 30 minutes
C. All Emails in the last hour
D. All Emails in the last 24 hours.
1. All Emails from people in “My Friends” address group
2. All Emails from people at Company 1
3. All Emails sent to people at Company 2.

The ability to allow users to easily (i.e. drag-n-drop) combine perspectives allows for more refined searches to quickly and easily be generated. So if I have Perspective 2 open (All Emails from people at Company 1) I can drag in Perspective 3 to make that perspective now (All Emails from people at Company 1) sent to people at Company 2). Furthermore I can drag in Perspective A and it becomes (All Emails from people at Company 1 sent to people at Company 2 in the last 10 minutes).

This is very powerful—from a small set of basic defined perspectives we can easily create very sophisticated email perspectives through drag-n-drop combination. Most people are going to be very ad-hoc and reactive about what email perspective views they want to see and the ability to combine simple perspectives like this allows them to generate the appropriate perspective in near-real-time.

### Information Returned by Perspective Queries

Perspective queries will generally return a list of emails from the Library Archive 19 which fall within the Perspective. The user can then access each of the emails from their mail browser. Alternatively or additionally, however, a Perspective could return other email information e.g. from the Library Index 18 such as the email Subject Matter Head or other information.

### Security

The server 11 and database 10 also implement secure access protocols. Managing email information across an entire organisation requires that information is held in a secure manner that protects access to such data, providing appropriate levels of privacy within the organisation. For example, the CEO may want access to all company emails, but only allow his Personal Assistant to access to his emails. The Sales Manager may require access to all his immediate Sales staff emails, but nobody from R&D should have access to the Sales email.

The TEAL server 11 incorporates security protocols to:
Ensure all retrieval of email from the system is fully authenticated and verified. For any given request made of the TEAL server 11, it knows who the end user making that request is.
Provide hooks for integrating the authentication process with LDAP or MSAD based authentication schemes.
Allow Administrators to configure which email accounts each end user has access to, or which sub-sets of email accounts a user has access to (for instance, only allowing the Sales staff to have access to each other Sales staff email accounts for email messages sent and received by registered Sales customers).
Provide a rule based means of generating access settings. For example allow anybody access to emails that have been received from Client X.
Ensure that users can only see emails in the database 10 for which they have access to.
Allow the ability for an audit trail of which users accessed which emails and when it was accessed to be maintained by the system.
Recognise distribution lists used by the organisation email system and provide access rules based on those lists. For example, allow any member of the sales distribution list access to emails from client Y.

Whilst the apparatus provides privacy and security mechanisms, it should also go hand in hand with organisational policy practices to ensure staff know who has a right to read their email.

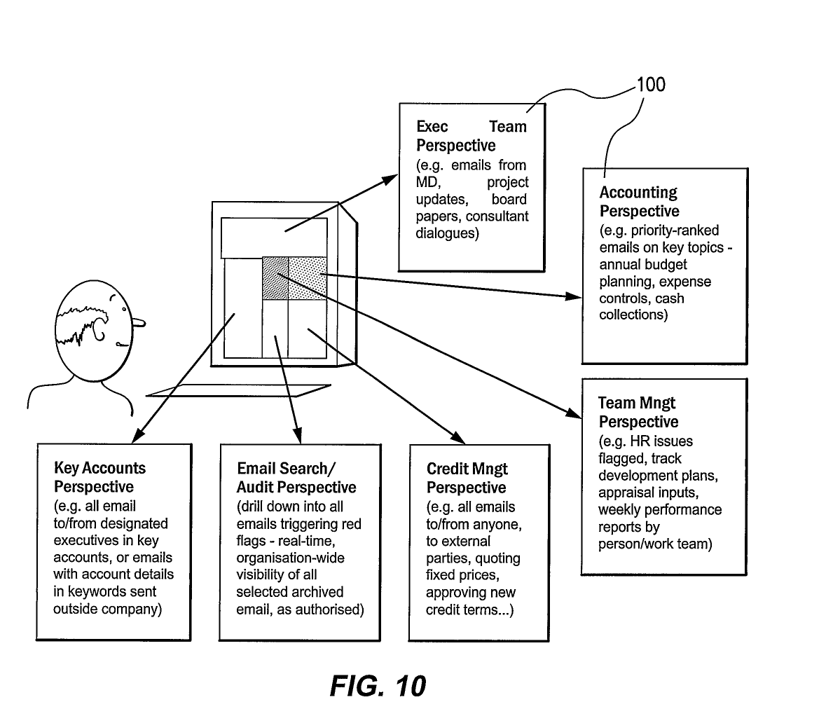

An example of use of Perspectives in an Inbox will now be given. “Brian's” Inbox under a TEAL environment might look (conceptually) like the diagram of FIG. 10.

These concurrently updated discrete Perspectives 100 appear automatically, as tabbed email screens in the familiar format, requiring no adjustment or learning by the user. The content has been transparently archived at the moment of arrival (or of sending, internally) with complete security. Logically, each email can be presented to multiple people in multiple Perspectives each defined uniquely by that use—but with only a single electronic copy in fact being archived, until a change occurs.

We will now take each of Brian's own Perspectives in turn and look at how the email content is presented in ways that meet Brian's priorities and way of working far better than with the standard Inbox—resulting in significant productivity improvements and fewer hours a day lost at the computer.

We will then look at the retrieval and investigative facilities provided, also on a drag and drop basis, to Brian and any other user, for maximum personal productivity and better management of corporate information.

Brain's Email Perspective #1: “Accounting Management”
Accounting Management Perspective 5 New Emails (3 High Priority)

| Subject | To | From | Time | Priority |
|---|---|---|---|---|
| Delinquent account # | AP.clerk@ChannelPartner22.com | NSWClerk.3@ourcompany.com.au | 11:31 am | High I |
| 321776 II | | | 17/01/05 | |
| Audit Results - Qid | Finance.Mngt@ourcompany.com.au | Auditor1@KPMG.com.au | 11:28 am | High I |
| Warehouse Division | | | 17/01/05 | |
| Timetable for Annual | Finance.Management Team | A.N.Other.Mngt.Accountant@ourcompany.com | 11:15 am | High I |
| Budgeting Program - | | | 17/01/05 | |
| new info | | | | |
| Timetable for Annual | Finance.Team@ourcompany.com.au | A.N.Other.Mngt.Accountant@ourcompany.com | 09:33 am | High I |
| Budgeting Program | | | 17:01:05 | |
| Cash balances by state | Fin.Controllar@ourcompany.com.au | Finance.ManagementTeam@ourcompany.com | 09:29 am | High I |
| office - flash report | | | 17/01/05 | |
| Urgent - Expense Blowout | Norman.CEO@ourcompany.com.au | Brian. CFO@ourcompany.com | 03:2 6am | High I |
| 4Q′04 !!!!!!!!!!!!!!!! | | | 17/01/05 | |
| New Bank Account - HK | Brian.CFO@ourcompany.com | HK.GM@ourcompany.com.hk | 10:43 am | Med |
| Subsidiary | | | 17/01/05 | |
| Re: Weekly Inventory | Brian.CFO@ourcompany.com | A.Mngt.Accountant@ourcompany.com | 10:42 am | Med |
| Report - 10/1/2005 | | | 17/01/05 | |
| amended | | | | |
| Weakly Inventory Report - | Brian.CFO@ourcompary.com | A.Mngt.Accountant@ourcompany.com | 12:14 pm | Med |
| 10/1/2005 | | | 14/01/05 | |
| Meeting with Comm Bank | Brian.CFO@ourcompany.com.au | John.Secretary@ourcompany.com.au | 10:33 am | Med |
| Executive - 20 Jan: Details | | | 17/01/05 | |
| Layer 3 process redesign: | BizProcess.DistList@ourcompany. | Process.Guru@consultant.co.uk | 11:15 am | Low |
| Process 4321 “ARec” | com.au | | 17/01/05 | |

This is the “Accounting Management Perspective” that Brian has pre-configured by simple selections by mouse from menu options, to give him his preferred format for optimal email visibility of the work-flow:
Brian has chosen to have email presentation based on Keywords selected by Brian—“delinquent”, “audit”, budgeting” etc (from a menu, updated by adding from subsequent emails via a ‘dictionary’-like addition/deletion mouse click)—regardless of time received and to whom in Finance Department addressed.
Sorted within Priority to present emails on the same Subject in descending time series (either listed serially or concatenated into a single chain—his choice).
Brian optionally could have selected to have the “To” or “From” columns presented according to his priorities/preferences (e.g. immediate management team, specific offices, etc) within Priority categories.
Note that this view spans not just Brian's normal emails, but also emails in the archive that of other email accounts that he, as CFO, has been set up to access.

Brain's Email Perspective #2: “Credit Management”
Credit Management Perspective 4 New Emails (4 High Priority)

| Subject | To | From | Time | Priority |
|---|---|---|---|---|
| Credit over-extended - Cust # | Brian.CFO@ourcompany.com | Finance.Mngr1@ourcompany.com.au | 11:39 am | High |
| 023776 (W.A. Office) - | | | 17/01/05 | |
| escalating process concernt | | | | |
| Credit over-extended - Cust # | Finance.Mng1@ourcompany.com.au | WA.Manager@ourcompany.com.au | 11:16 am | High |
| 023776 (W.A. Office) - | | | 17/01/05 | |
| explanation and next steps | | | | |
| Credit over-extended - Cust # | Finance.Mng1@ourcompany.com.au | WA.Manager@ourcompany.com.au | 10:22 am | High |
| 023776 (W.A. Office) - checking | | | 17/01/05 | |
| it out now | | | | |
| Credit over-extended - Cust # | WA.Manager@ourcompany.com.au | Finance.Mngr1@ourcompany.com.au | 08:44 am | High |
| 023776 (W.A. Office) | | | 17/01/05 | |
| Part Payment - Cust # 232289 | AR.Mngr@ourcompany.com.au | CustARClerk3@BigCust.com.sgp | 11:30 am | High |
| | | | 17/01/05 | |
| New Credit Scoring System - | Finance.Management Team | Process.Guru@consultant.co.uk | 10:04 am | High |
| timetable to implement | | | 17/01/05 | |
| Credit Dept Budget 1H05 | Finance.Team@ourcompany.com.au | A.N.Other.Mngt. | 09:33 am | High |
| | | Accountant@ourcompany.com | 17:01:05 | |
| New Customer - Credit Request | Brian. CFO@ourcompany.com | NZ.GM@ourcompany.com.hk | 07:44 am | High |
| $150,000 | | | 17/01/05 | |
| Weekly Accts Rec Report - | Brian. CFO@ourcompany.com | A.Mngt.Accountant@ourcompany.com | 09:02 am | Med |
| 10/1/2005 - with NZ | | | 17/01/05 | |
| Weekly Accts Rec Report - | Brian. CFO@ourcompany.com | A.Mngt.Accountant@ourcompany.com | 20:29 pm | Med |
| 10/1/2005 - w/out NZ | | | 14/01/05 | |
| Meeting with SAP account | Brian. CFO@ourcompany.com.au | John.Secretary@ourcompany.com.au | 19:00 pm | Med |
| manager - 27 Jan: changes | | | 14/01/05 | |
| Credit Dept Social drinks - | Finance.Team@ourcompany.com.au | John.Secretary@ourcompany.com.au | 18:32 pm | Low |
| Thursday at 6.30pm | | | 14/01/05 | |

This is the concurrently running “Credit Management Perspective” that Brian, our busy CFO, configured to track activity relating to Credit Management policy and processes. He again configured this via selections by mouse from menu options, to give him his preferred format for optimal visibility and work-flow:
Email presentation has been selected by Brian on a Key Issues basis by named Senders or Recipients, regardless of time received and to whom in the Company addressed, relating to those Credit, Risk and Payment Keywords and to key Internal and Customer recipients.
All Credit emails to any recipient with an external email domain name (i.e. not “ourcompany.com”) are also selected as priority items in this Perspective—Brian wants to know who is being informed of or promised Credit terms.
In this case, the Perspectives approach allows Brian to immediately track the escalating Credit issue in W.A., approve the new customer credit limit in NZ so a transaction can proceed and check the weekly AR report as first priorities, while reserving other items for later processing after checking his other Perspectives.

Brian's Email Perspective #3: “Key Customer Accounts”
Key Customer Account Perspective 6 New Emails (3 High Priority)

| Subject | To | From | Time | Priority |
|---|---|---|---|---|
| BHP Customer Exec visit to | Brian.CFO@ourcompany.com | SalesMngr@ourcompany.com.au | 10:04 am | High |
| HQ 24 Jan - agenda vers 2 | | | 17/01/05 | |
| BHP Customer Exec visit to HQ | Brian. CFO@ourcompany.com | SalesMngr@ourcompany.com.au | 19:32 pm | High |
| 24 Jan - agenda input req'd | | | 13/01/05 | |
| BHP Customer Exec visit to HQ | SalesMngr@ourcompany.com.au | BHP.SalesMgr@ourcompany.com.au | 16:44 pm | High |
| 24 Jan - request for CFO | | | 12/01/05 | |
| presentation | | | | |
| CBA Ltd - Credit Limit Increase | Customer.CFO@CustCo.com.hk | HK.GM@ourcompany.com.hk | 08:54 am | High |
| USD 2,000,000 approved - | | | 17/01/05 | |
| confidential | | | | |
| CBA visit to Singapore office | SalesMngr@ourcompany.com.au | CBA.SalesMgr@ourcompany.com.au | 08:03 am | Low |
| | | | 17/01/05 | |
| Meeting with your CEO re Nov | Deputy.CEO.@BigCorp.com.in | SalesDirector@ourcompany.com.au | 09:52 am | Med |
| proposal - 29 Jan 05 in | | | 17/01/05 | |
| Jakarta | | | | |
| Does anyone have contact at | ExecTeam@ourcompany.com.au | FinanceMngr1@ourcompany.com.au | 19:31 pm | Low |
| BigCorp in NZ ? | | | 14/01/05 | |
| Bidding together for Westpac | Partner.Director@IBM.com.au | SalesMngr@ourcompany.com.au | 09:05 am | Med |
| account - new plan | | | 14/01/05 | |
| Exec Calling Plan 1Q05 draft | ExecTeam@ourcompany.com.au | SalesMngr@ourcompany.com.au | 10:10 am | High |
| | | | 17/01/05 | |
| Re: Exec Calling Plan Results | ExecTeam@ourcompany.com.au | SalesMngr@ourcompany.com.au | 07:09 am | High |
| 4Q04 - file appended this time, | | | 17/01/05 | |
| sorry | | | | |
| Exec Calling Plan Results | ExecTeam@ourcompany.com.au | SalesMngr@ourcompany.com.au | 07:03 am | High |
| 4Q04 | | | 17/01/05 | |
| Key Customer Weekly Report - | SalesDirector@ourcompany.com.au | BizMngr@ourcompany.com.au | 15:33 pm | Med |
| 10/1/2005 - with NZ | | | 14/01/05 | |

This is the concurrently running “Key Customer Account Perspective” that Brian configured to track activity relating to the top 10 key accounts for the Company as an executive responsible for specific Customer Executive relationships. He again configured this via selections by mouse from menu options, to give him his preferred format for optimal visibility and work-flow:
Priority-based email listed by nominated Key Account and with “To/From” selected for key job titles/email addresses within the customer account and our company (i.e. all material correspondence to & from the customer accounts is made visible).
Allows Brian to immediately react to any Key Account issues as a member of the Executive team while tracking other plans and programs for those accounts.

Brian's Email Perspective #4: “Executive Team”
Key Customer Account Perspective 6 New Emails (3 High Priority)

| Subject | To | From | Time | Priority |
|---|---|---|---|---|
| Executive meetings this Qtr - | ExecTeam@ourcompany.com.au | Norman.CEO@ourcompany.com.au | 10:01 am | High |
| my team | | | 17/01/05 | |
| Governance Risks - concerns | ExecTeam@ourcompany.com.au | Norman.CEO@ourcompany.com.au | 09:47 am | High |
| from our Chairman | | | 17/01/05 | |
| Cash position - can we afford a | Brian.CFO@ourcompany.com.au | Norman.CEO@ourcompany.com.au | 09:45 am | High |
| hostile takeover of JuicyCo? | | | 17/01/05 | |
| Drinks at my place this Sat - | ExecTeam@ourcompany.com.au | Norman.CEO@ourcompany.com.au | 10:10 am | Med |
| RSVP | | | 17/01/05 | |
| Teambuilding Exercise No. 3 - | ExecTeam@ourcompany.com.au | Norman.CEO@ourcompany.com.au | 09:33 am | Low |
| half day session 14 February | | | 17/01/05 | |
| CBA visit to Singapore - do you | SalesDirector@ourcompany.com.au | Norman.CEO@ourcompany.com.au | 08:03 am | Low |
| need my help? Will be golfing. | | | 17/01/05 | |
| What the heck is up with | Brian.CFO@ourcompany.com.au | TrustedBuddy1@hotmail.com | 09:57 am | Med |
| Norman ?? Any scuttlebutt? | | | 17/01/05 | |
| Did you hear what happened to | Brian.CFO@ourcompany.com.au | TrustedBuddy2@ourcompany.com.au | 08:22 am | Low |
| Fred at the weekend ! | | | 17/01/05 | |
| HR Policy development - | ExecTeam@ourcompany.com.au | HR.Director@ourcompany.com.au | 19:01 pm | Med |
| briefing for Exec Team | | | 14/01/05 | |
| Business-only use of Email - | ExecTeam@ourcompany.com.au | IT.Director@ourcompany.com.au | 04:33 am | High |
| your support is needed please | | | 17/01/05 | |

This is the “Executive Team Perspective” that Brian configured to manage his participation as a key member of senior management. He again configured this via selections by mouse from menu options, to give him his preferred format for optimal visibility and work-flow:
Email prioritised by Sender—first, his CEO; next, his 3 most trusted Executive confidants; and then finally the complete list of the fellow members of the Executive team.
This Perspective is password protected by Brian so that even his secretary, using his desktop to check emails for him cannot access it. Nevertheless the content is fully archived for use in any enquiry or future investigation.

Brian's Email Perspective #5: “My Team”
Key Customer Account Perspective 6 New Emails (3 High Priority)

| Subject | To | From | Time | Priority |
|---|---|---|---|---|
| Finance Team meetings 1Q05 | FinanceTeam@ourcompany.com.au | John.Secretary@ourcompany.com.au | 10:55 am | High |
| | | | 17/01/05 | |
| Finance Team meetings 1Q05 - | Brian.CFO@ourcompany.com.au | John.Secretary@ourcompany.com.au | 08:21 am | High |
| do you want me to circulate | | | 17/01/05 | |
| now? | | | | |
| Finance Team meetings 1Q05 - | Brian.CFO@ourcompany.com.au | John.Secretary@ourcompany.com.au | 19:22 pm | High |
| HR hassling you to | | | 12/01/05 | |
| confirm done | | | | |
| Development Plan - reworked | Brian.CFO@ourcompany.com.au | AcctgMgr4@ourcompany.com.au | 09:59 am | Med |
| as per mtg last Thurs | | | 17/01/05 | |
| Development Plan - draft from | Brian.CFO@ourcompany.com.au | AcctgMgr4@ourcompany.com.au | 16:02 am | Med |
| Thurs review | | | 14/01/05 | |
| Development Plan - have | Brian.CFO@ourcompany.com.au | FinancialController3@ourcompany.com.au | 08:21 am | Low |
| drafted for yr approval | | | 13/01/05 | |
| Development Plan - where do I | Brian.CFO@ourcompany.com.au | FinancialController1@ourcompany.com.au | 15:33 pm | Low |
| find template form? | | | 12/01/05 | |
| Development Plans - Finance | Brian.CFO@ourcompany.com.au | HR.Director@ourcompany.com.au | 12:16 pm | Med |
| Dept have not lodged yet?? | | | 14/01/05 | |
| Resignation - in confidence | Brian.CFO@ourcompany.com.au | Slack.Harry@ourcompany.com.au | 17:45 pm | High |
| | | | 14/01/05 | |
| Acceptance of offer | Brian.CFO@ourcompany.com.au | Keen.Recruit@hotmail.com | 09:33 am | High |
| | | | 14/01/05 | |
| Promotion Announcement - | FinanceTeam@ourcompany.com.au | John.Secretary@ourcompany.com.au | 10:49 am | High |
| Jim Bloggs - on behalf of | | | 17/01/05 | |
| Brian | | | | |
| Anti-Discrimination Policy - | Finance.Department@ourcompany. | HR.Director@ourcompany.com.au | 13:21 pm | High |
| reminder | com.au | | 13/01/05 | |
| Non-Smoking Policy - cigarette | Finance.Department@ourcompany. | HR.Director@ourcompany.com.au | 13:21 pm | High |
| butts found in stairwells again! | com.au | | 13/01/05 | |
| Request for job interview - CV | Brian.CFO@ourcompany. | Referred.Jobseeker@yahoo.com.au | 09:32 am | Low |
| attached | com.au | | 14/01/05 | |

This is the “My Team” Perspective that Brian's P.A. configured to manage his role as manager of a large and geographically dispersed team. He again configured this via selections by mouse from menu options, to give him his preferred format for optimal visibility and work-flow:
Email prioritised by Key Tasks—first, his Team Meetings; next, Development; thirdly, Recruitment and Placement (key words: “job offer”, “resignation” “etc as a filter); fourthly, Policy/Process topics; and finally, all “other” such as unsolicited email with certain keywords.

Email Perspectives. Email Perspectives are implemented as a logic Tree data-structure with AND/OR/NOT branch nodes and different “criteria” leaf nodes. This is highly “email” specific—the criteria relate to email meta-data such as Subject, Distribution, Attachments, Content, Priority, Date etc. By representing Email Perspectives as tree structures they are easily “combinable” together to AND/OR together separate perspectives to drill-down or drill-up on the result set accordingly. For example, this is used in the engine to enforce security permissions by AND'ing a permissions perspective with any perspective the user wants to execute.

Under the hood, Email Perspectives are stored and communicated across the wire in XML format. This provides a generic, portable storage medium for the definition of email perspectives.

Here are some examples:

```
<perspective id=“229116” name=“Everything” type=“AND”>
    <metaData>
        <metaDataItem key=“emailSearchType”
        value=“QUICK_SEARCH”/>
    </metaData>
    <CriteriaNode type=“Sort”>
        <SortCriteria on=“Sent Timestamp” order=“Descending”/>
    </CriteriaNode>
</perspective>
<perspective id=“229191” name=“Last Month” type=“AND”>
    <metaData>
        <metaDataItem key=“emailSearchType”
        value=“QUICK_SEARCH”/>
    </metaData>
    <CriteriaNode type=“Sort”>
        <SortCriteria on=“Sent Timestamp” order=“Descending”/>
    </CriteriaNode>
    <CriteriaNode type=“Rolling Timespan”>
        <metaData>
            <metaDataItem key=“forEmailSearchCriteria”
value=“timespanCriteria”/>
            <metaDataItem key=“timespanType” value=“MONTHS”/>
        </metaData>
        <RollingTimespanCriteria maxAgeMs=“2678400000”
        minAgeMs=“0”/>
    </CriteriaNode>
</perspective>
<perspective id=“223788” name=“developers@mel.hyro.com”
type=“AND”>
    <metaData>
        <metaDataItem key=“emailSearchType”
        value=“QUICK_SEARCH”/>
    </metaData>
    <CriteriaNode type=“Sort”>
        <SortCriteria on=“Sent Timestamp” order=“Descending”/>
    </CriteriaNode>
    <CriteriaNode type=“Distribution”>
        <metaData>
            <metaDataItem key=“forEmailSearchCriteria”
value=“distributionCriteria”/>
        </metaData>
        <DistributionCriteria contactRef=“SearchGroup:
{Domain, Email Account}developers@mel.hyro.com” qualifier=“To”/>
    </CriteriaNode>
</perspective>
<perspective id=“229296” name=“Java Content” type=“AND”>
    <metaData>
        <metaDataItem key=“emailSearchType”
        value=“QUICK_SEARCH”/>
    </metaData>
    <CriteriaNode type=“Sort”>
        <SortCriteria on=“Sent Timestamp” order=“Descending”/>
    </CriteriaNode>
    <CriteriaNode type=“Content”>
        <metaData>
            <metaDataItem key=“forEmailSearchCriteria”
value=“contentSearchCriteria”/>
        </metaData>
        <ContentCriteria includeUnparsable=“false” qualifier=“Match
Any” search=“java”/>
    </CriteriaNode>
</perspective>
```

And here is an example of what happens when security permissions are enforced in the engine, appending a “security distriubtion” branch to the perspective. In this example a search for everything is being executed by a user with a security restriction of only accessing emails from or to the coolrocksoftware.com domain:

```
<perspective id=“1164753374529” name=“temp” type=“AND”>
    <metaData>
        <metaDataItem key=“emailSearchType”
        value=“QUICK_SEARCH”/>
    </metaData>
    <CriteriaNode type=“Sort”>
        <SortCriteria on=“Sent Timestamp” order=“Descending”/>
    </CriteriaNode>
    <BranchNode type=“AND”>
        <CriteriaNode type=“Distribution”>
            <DistributionCriteria contactRef=“User Defined Group:
[Domain:coolrocksoftware.com]” qualifier=“NULL”/>
        </CriteriaNode>
    </BranchNode>
</perspective>
```

Under the hood, the Email Engine's ECL Index (Email Content Library) plug-in implementation is responsible for translating the above XML definitions into underlying SQL to run against the database. For example, the above security enforced perspective compiles to the following database query:

SELECT distinct email.id, email.* FROM Email WHERE (((email.id in
(select distinct(email.id) from email, EmailDistribution where
email.id = EmailDistribution.emailid and (EmailDistribution.domainid
= 1164079771939))))) AND recordstate = 1 ORDER BY
sentTimestamp desc

Another example of where the engine applies some smarts is where a full-text criteria is applied. In this case, the engine first searches the full-text index (a file system based index), adds the results into the database so it can be joined on by a SQL query, then cleans up the temporary “search results” from the database. This allows the query to be executed entirely in the database although there are non database components involved in providing part of the search results (e.g. “content search for the keyword ‘perspectives’”):

```
<perspective id=“1164753708714” name=“temp” type=“AND”>
    <metaData>
        <metaDataItem key=“emailSearchType”
        value=“QUICK_SEARCH”/>
    </metaData>
    <CriteriaNode type=“Content”>
        <metaData>
            <metaDataItem key=“forEmailSearchCriteria”
value=“contentSearchCriteria”/>
        </metaData>
        <ContentCriteria includeUnparsable=“false” qualifier=“Match
Any” search=“perspectives”/>
    </CriteriaNode>
    <CriteriaNode type=“Sort”>
        <SortCriteria on=“Sent Timestamp” order=“Descending”/>
    </CriteriaNode>
    <BranchNode type=“AND”>
        <CriteriaNode type=“Distribution”>
            <DistributionCriteria contactRef=“User Defined Group:
[Domain:hyro.com]” qualifier=“NULL”/>
        </CriteriaNode>
    </BranchNode>
</perspective>
SELECT distinct email.id, email.* FROM Email WHERE ((email.id IN
(SELECT emailid FROM librarianresult WHERE
LibrarianResult.resultId = ?)) AND ((email.id in (select
distinct(email.id) from email, EmailDistribution where email.id =
EmailDistribution.emailid and (EmailDistribution.domainid =
1164079771939))))) AND recordstate = 1 ORDER BY sentTimestamp
desc
```

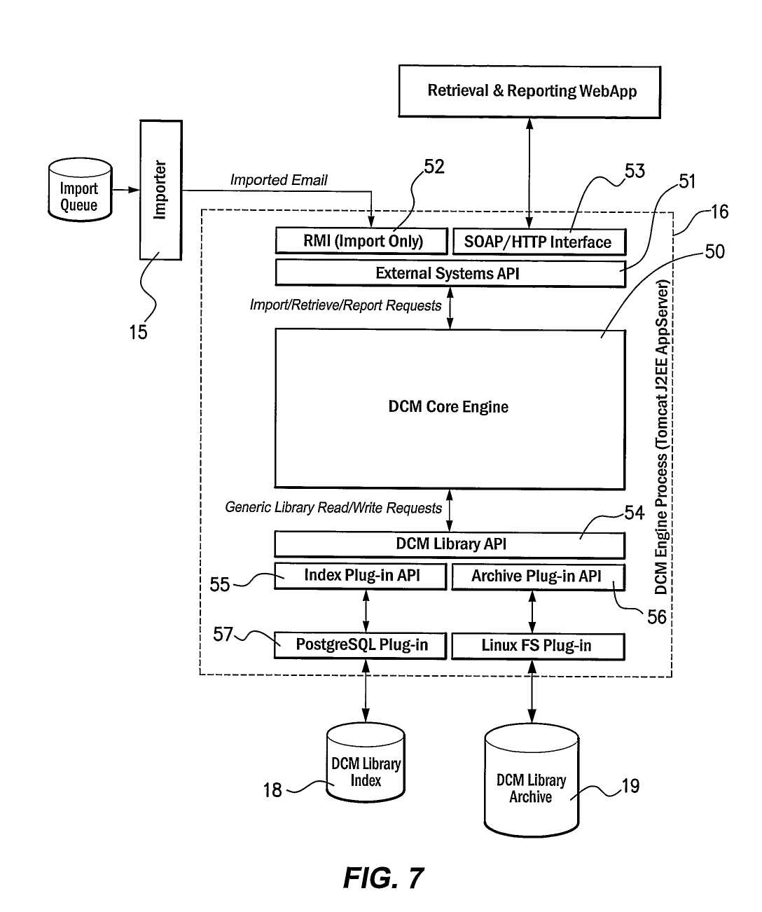

Referring now to FIG. 7, a more detailed description of the DCM Engine 16 implementation will be given.

The DCM Engine 16 is comprised of a number of internal interfaces and processes running on a single Tomcat application server. Its function is to import new digital content (emails) into the Library 10, co-ordinate requests for content retrieval and report information from external clients.

Internally, the Core Engine 50 handles the import and retrieval requests received via its External Systems API 51. In this embodiment, we are providing both RMI and SOAP over HTTP 53 inter-process communication (IPC) mechanisms for the Importer/Retrieval and Reporting WebApp to access the Library 10. The RMI interface 52 and SOAP/HTTP interface 53 form the interface 17 as schematically illustrated in FIG. 3, together with the external systems API for API 51.

The DCM Engine 16 acts as a central co-ordinator for all actions on the database 10 (also termed the “DCM Library”). Internally it utilises a DCM Library API 54 to access the Library 10. This allows for custom plug-ins for particular storage mediums to be designed and added to the engine in such a way that both the Core Engine 50 and all its externally communicating processes remain isolated from the technical implementation details of how the Library 10 is implemented. This will allow for future reuse for other digital content management activities.

The Core Engine 50 is responsible for taking the Imported email data and storing it appropriately in the Library 10. At a high level, the responsibilities of the Core-Engine can be broken into three categories.

Email Importing and Storage Management
Normalise key relationship data such as Date, Subject, To, From, CC, BCC, Content and Attachments.
Store email meta-data in the Library Index (relational database).
Store raw email content and attachments in the Library Archive (file system).
Identify and eliminate duplicate emails.

Email Retrieval
Handle query requests to retrieve header information for emails stored in the Library.
Handle query requests to retrieve the body and attachment contents of a given email.

Reporting and Monitoring
Collate traffic and storage statistics on the library and use them to generate periodic reports and graphs that can be served up to the Reporting WebApp to monitor performance.

### External Systems API

The External Systems API 51 provides a generic way of interfacing to the Core Engine in-process. It provides interface calls to import new email into the Library and execute email retrieval queries on the Library content. Different IPC implementations of the External Systems API can be used to expose this functionality for external processes to access. In this embodiment RMI 52 and HTTP/SOAP 53 are provided.

### RMI Interface

The RMI interface 51 is for import only and is aimed at providing a high-throughput means of inter-process communication between the Importer and the Engine, both of which are Java processes running locally on the same server.

### HTTP/SOAP Interface

The HTTP/SOAP Interface 53 exposes the External Systems API as a SOA style interface that can be accessed via SOAP over HTTP. This interface is used by the Email Retrieval and Reporting WebApp to provide a user-interface into the DCM Library 10. Note that other interface technologies can be utilised in other embodiments.

### DCM Core Engine

The core engine 50 receives requests to import email and retrieval/reporting requests via the External Systems API. It is responsible for co-ordinating those requests using the Library API. As the Engine runs in a Tomcat J2EE Application Server, it will support a scalable, multi-threaded request engine that can handle multiple inbound requests from the Importer and end users via the WebApp Interface.

### DCM Library API

The Library API 54 provides a technology independent interface into the DCM library 10 for the Core-Engine 50 to use in processing inbound import and retrieval requests. A plug-in architecture allows for different storage technologies to be used in implementing the Library 10 transparently to the Core-Engine 50. This will allow different and multiple simultaneous database and file systems to be used with TEAL in the future with minimal impact on the Engine system.

In this case, the plug-ins are illustrated as Index Plug-In API 55 and Archive Plug-In API 56.

### PostgreSQL Plug-In

In this embodiment a PostgreSQL plug-in 57 implements the Library Index using a PostgreSQL database.

### Linux FS Plug-In

Linux FS plug-in 58 that implements the Library Archive using the Java IO APIs, but tuned for optimal performance on a Linux file system.

The Core-Engine 50 can be used with multiple plug-ins concurrently. For example, a company may be using Oracle™ for its database storage, so the Engine 50 uses a Oracle™ database plug-in.

This architecture has a number of advantages. If a company wishes to migrate to another database type of architecture, for example, they can phase this in over a period of time still using the email system of this embodiment of the present invention. For example, if they wish to migrate from Oracle to Postgres, all that is required is the Postgres Plug-in is added to the Core-Engine 50 so it can communicate with both Oracle and Postgres databases. New emails may now be stored in the Postgres database, whilst for now the old email and email meta-data continues to be managed by the Oracle database. A query to retrieve a set of emails may result in both databases being queried (transparently from the end user).

### Handling of Duplicates and Attachments

Emails being processed by the apparatus of this embodiment are checked to see if they are a duplicate of an already existing email. Each email will have a MD5 hash code calculated based on its contents (128 bit key with an extremely low probability of two binary files having the same key) and the hash code is stored in the database. As new emails arrive, their MD5 hash code is quickly compared with other codes in the database—if it already exists the email can safely be considered a duplicate. The duplicate does not need to be processed and stored, and in this embodiment it will not be.

Attachments are stored separately from email content in the file system, with the database 10 maintaining the relationship info (i.e. which attachment belongs to which emails)—this is a 1:many relationship, so a given attachment that may exist in several emails is only stored once on the file system, saving disk space. The process of recognising identical attachments is also done through an MD5 hash code (as there may be several different versions of “patent.doc”, all with the same name and possibly the same size, so we identify identical attachments based on binary contents).

### DCM Library 10

As discussed above, the DCM Library 10 is comprised of two parts: the Library Index 18 and the Library Archive 19. The Index 18 is a relational database that maintains indexes and tables relating to the email meta-data mined from the email. The Archive 19 is a scalable file based storage of the actual email content (header, body and attachments).

The Library Index 18 and the Library Archive 19 are directly related to each other and are both maintained by the DCM Engine 16 when new emails are imported into the Library 10.

When retrieving emails, the Library Index 18 provides a relational and indexed view of the email data held in the Library Archive 19 and can be used to quickly identify and find particular emails in the file based archive 19.

### Unique Identification

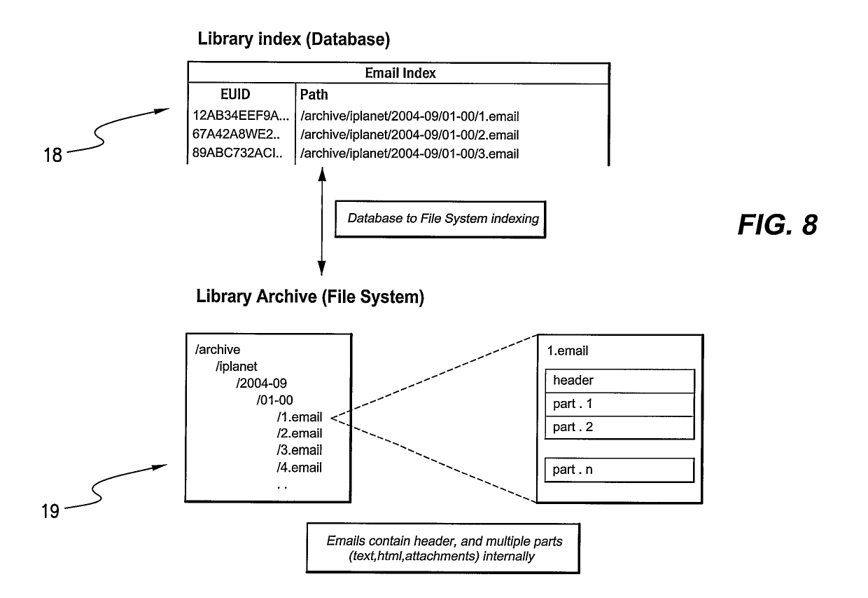

Referring to FIG. 8, emails are uniquely identified and tracked in the DCM Library 10 by means of a Email Unique Identifier (EUID). When captured emails are first Processed for storage in the DCM Library 10, they will have a EUID assigned to them as a first step.

The EUID is generated from performing a 128 bit MD5 identifier based on the internal contents of the message as discussed above.

Once an EUID has been assigned, all database records associated with that email in the Library Index 18 can be retrieved using that given identifier.

### Library Index

The DCM Enginer 16 receives parsed email content from the Importer 15 that has identified the meta-data information from their header content for relational storage in the Library Index 128. The meta-data may include:
Subject
Date
From
To Recipients
CC Recipients

It may include further information, as discussed above, including information from the email content. This information is stored and tracked against the Email's EUID.

### Library Archive

The Library Archive 19 uses organised directories and files on the TEAL system to store the raw email content (header, body and attachments). See FIG. 8.

When captured Emails are received and processed, their raw content will get placed in a single file in the Library Archive. The directory the files are stored in is dynamically determined based on the current system time and the domain the email belongs to.

Email files are linked to their EUID through the main Email Index table in the Library Index 18. A path field in that table allows the corresponding file in the Archive to be identified for any given email in the Index. Example table extracts for the Library Index 18 and Library Archive 19 are illustrated in FIG. 8.

### Duplicate Email Elimination

It will be possible for the same email to be captured and sent to the TEAL Server 11 multiple times. The TEAL System will ensure that only one copy of the email is stored in the DCM Library 120 by identifying and ignoring duplicate emails.

The DCM Engine 10 will be responsible for identifying duplicates by:
1. Generate an EUID for a captured email based on its raw binary content.
2. Check to see if that EUID already exists in the system. If so then the email is considered to be a duplicate.

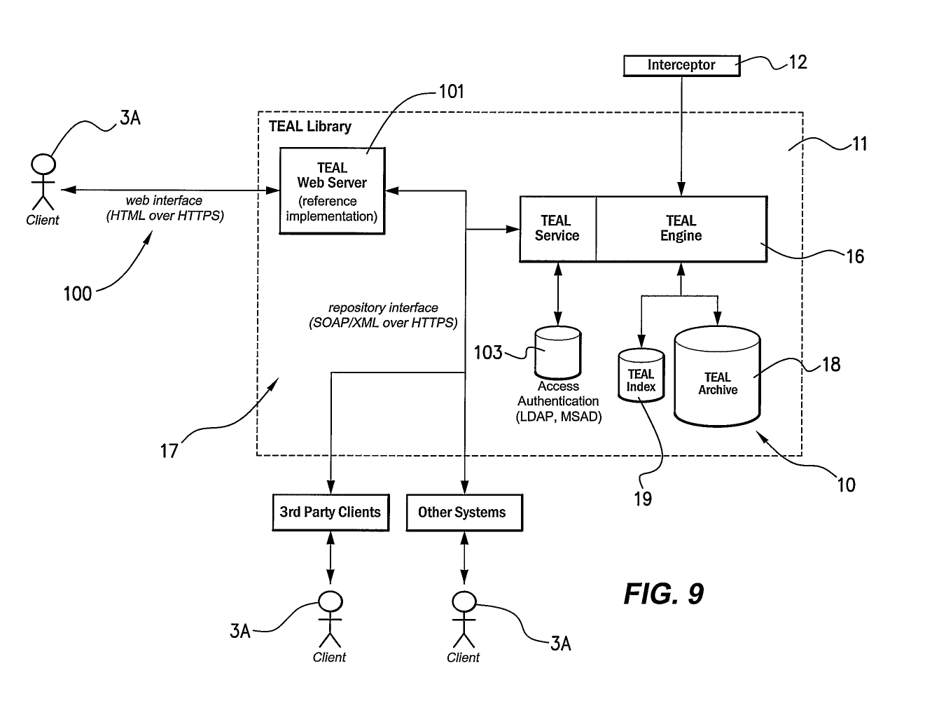

FIG. 9 illustrates implementation of an alternative embodiment of the present invention. The embodiment shows some more detail on how an Interface 17 of the FIG. 3 apparatus could be implemented. The components of the FIG. 9 embodiment have the same function as equivalent components of the FIG. 3, they have been given the same reference numerals and no further description of them will be given.

The Interface is generally indicated by reference numeral 17. The Interface 17 provides a SOA style surface that provides a SOAP interface, accessed over a secure HTTPS connection 100. This provides the following architectural advantages:
The interface is geared towards talking to computer clients rather than human clients
The web interface 101 can be built on top of the SOAP interface to provide a human client interface.
Open, standards based interface allows third party tools to develop custom client interfaces using a variety of technologies.
Open, standards based interface allows external systems to easily integrate into the apparatus and the leverages capabilities.

At a high level, the SOAP interface will provide access to the to following capabilities of the system.
Authenticated session management 103. All access to the system must be authenticated to ascertain end client permissions and to provide an accurate access audit trail.
Email query interface allows for complex mail queries to be defined, saved and executed to return a set of mail header information matching that query and the client's access level.
Retrieval of mail contents and attachments for a particular mail header if the end client has permission to access that information.
Administration (if the end client is permitted) of system users and their authentication levels and rights.
Administration (of the end client is permitted) of mail archiving and purging policies.

The system will protect the privacy of the data it is handling (which in many cases may be a legal requirement, not just corporate policy) through the following mechanisms:
Inbound mail message feeds from the Email Interceptors will be transmitted over an encrypted secure socket layer (SSL) connection to ensure the mail data remains private whilst in transit to the TEAL system.
Email indexing data sent ti the TEAL Index will utilise the security mechanisms supported by the database server hosting the index. For example, the Oracle JDBC driver can be used in SSL mode to communicate over a secure, encrypted channel with an Oracle database server.
The database and file systems hosting the TEAL Index and TEAL Archive data respectively, will utilise the infrastructure/operating system level security mechanisms provided by the vendors of those technologies to protect the data privacy

In the above embodiments, the apparatus of the present invention has been implemented utilising software and a server/client type architecture. It will be appreciated that other available hardware./software architectures may be used to implement the invention. For example, an appropriate mainframe and terminal type architecture may be used to implement an alternative embodiment of the invention.

In the above embodiments, an interface can either include all perspectives or combination of perspectives in conventional email folders. In another embodiment, in order to get users “use to” the idea of querying emails as oppose to the folder paradigm, an email perspective may be implemented as a special type of “email folder” aside from one that potentially could have different contents every time you looked at the folder from one that does not require emails to be filed in it. That is defined email perspective may be published as IMAP all in accessible folders and users can configure their traditional clients to point at the teal server and seeing where perspective folders in their client.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of storing and distributing emails in an organisation having a plurality of email users, comprising the steps of storing received emails in a database and distributing emails to users in response to a step of querying of the database, by search queries associated with the users.

2. A method in accordance with claim 1, wherein the step of querying the database is carried out by utilising a database query language.

3. A method in accordance with claim 2, comprising the further step of saving queries expressed in the query language so that the queries may be re-used.

4. A method in accordance with claim 3, comprising the further step of sharing queries between users.

5. A method in accordance with claim 2, comprising the step of providing one or more predefined queries for use by a user.

6. A method in accordance with claim 2, comprising the step of enabling email users to formulate their own queries.

7. A method in accordance with claim 2, wherein queries are able to be combined.

8. A method in accordance with claim 7, wherein queries may be combined in AND/OR/NOT style relationships.

9. A method in accordance with claim 2, wherein the database query language is a high level language that is database agnostic.

10. A method in accordance with claim 2, wherein the database query language has been particularly designed for email searching and retrieval.

11. A method in accordance with claim 2, comprising the step of implementing security by combining a security query with the queries.

12. A method in accordance with claim 2, wherein a query is able to access on behalf of a user all emails available in the database, regardless of the identity of the sender or identity of intended recipient.

13. A method in accordance with claim 2, wherein the step of storing comprises the step of storing emails received by the organisation directed to the organisations users.

14. A method in accordance with claim 13, wherein the step of storing comprises the step of storing emails sent by users within the organisation.

15. A method in accordance with claim 1, wherein emails are stored substantially in real time, when received or sent.

16. A method in accordance with claim 1, wherein the step of storing comprises storing the emails in a location separate from a standard email server processor of the organisation.

17. A method in accordance with claim 1, wherein the step of storing comprises the step of processing the emails to produce query index information.

18. A method in accordance with claim 16, wherein the step of storing comprises the step of storing the query index information in a first sub-database accessible to respond to queries.

19. A method in accordance with claim 18, wherein the step of storing comprises storing email content in a second sub-database.

20. A method in accordance with claim 18, wherein the step of querying is able to request that only query index information may be returned.

21. A method in accordance with claim 1, wherein the database comprises a relational database.

22. A method in accordance with claim 1, wherein the step of storing comprises identifying identical emails and storing only one version of the identical emails.

23. A method in accordance with claim 1, wherein the step of storing comprises identifying identical email attachments and storing only one version of the attachment.

24. A method of storing email received by an organisation, comprising the step of storing the email in relational form.

25. A method in accordance with claim 24, comprising the further step of storing the email substantially in real time as it is received by the organisation.

26. A method in accordance with claim 24, wherein the step of storing the email in relational form comprises the step of processing the emails to provide an index, the index being stored in relational form.

27. A method in accordance with claim 26, wherein the step of storing comprises the step of storing the index separately from email content.

28. A method in accordance with claim 24, wherein the step of storing comprises interfacing with an underlying database architecture via a plug-in type interface which enables different types of database architectures to be used for storage of emails.

29. An apparatus for storing and distributing email in an organisation having a plurality of email users, the apparatus comprising a database arranged to receive emails and a distribution means arranged to distribute emails to the email users in response to search queries to the database, the search queries being associated with the email users.

30. An apparatus in accordance with claim 29, further comprising a query means arranged to query the database, the query means utilising a database query language.

31. An apparatus in accordance with claim 30, wherein the query means is arranged to enable queries to be saved so that they may be re-used.

32. An apparatus in accordance with claim 31, wherein the query means is arranged to enable sharing of queries between users.

33. An apparatus in accordance with claim 30, the query means being arranged to enable preparation of pre-defined queries for use by the users.

34. An apparatus in accordance with claim 30, the query means being arranged to enable email users to formulate their own queries.

35. An apparatus in accordance with claim 30, the query means being arranged to enable queries to be combined.

36. An apparatus in accordance with claim 35, wherein the queries are combinable in AND/OR/NOT style relationships.

37. An apparatus in accordance with claim 30, wherein the database query language is a high level language that is database agnostic.

38. An apparatus in accordance with claim 37, wherein the database query language is specifically designed for email searching and retrieval.

39. An apparatus in accordance with claim 30, further comprising a security means, comprising a security query which is arranged to be combined with the search queries to implement security.

40. An apparatus in accordance with claim 29, wherein the query means is able to access all emails available in the database, regardless of the identity of the sender or identity of intended recipient.

41. An apparatus in accordance with claim 29, further comprising storing means, arranged to store in the database any emails received by the organisation directed to the organisation's users.

42. An apparatus in accordance with claim 41, wherein the storing means is arranged to store emails sent by users within the organisation.

43. An apparatus in accordance with claim 41, the storing means operating substantially in real time to store emails in the database.

44. An apparatus in accordance with claim 29, wherein the database is in a location separate from a standard email server of the organisation.

45. An apparatus in accordance with claim 29, comprising processing means for processing the email to produce query index information.

46. An apparatus in accordance with claim 45, wherein the database comprises a first sub-database storing the query index information.

47. An apparatus in accordance with claim 46, wherein the database comprises a second sub-database for storing email content.

48. An apparatus in accordance with claim 29, arranged so that only query index information may be returned in response to a query.

49. An apparatus in accordance with claim 29, the database comprising a relational database.

50. An apparatus in accordance with claim 29, the storing means comprising means for comparing emails and determining whether emails are identical, and in response for determination of emails are identical ensuring only one version of the email is stored.

51. An apparatus in accordance with claim 29, wherein the storing means is arranged to determine whether email attachments are identical and ensure that only a single attachment is stored where there are identical attachments.

52. An apparatus for storing email received by an organisation, comprising a relational database arranged to store the emails in relational form.

53. An apparatus in accordance with claim 52, further comprising storing means arranged to store email in the database in real time as it is received by the organisation.

54. An apparatus in accordance with claim 53, further comprising processing means arranged to process the emails to provide an index, the index being stored in the database in relational form.

55. An apparatus in accordance with claim 54, the index being stored separately from the email content in the database.

56. An apparatus in accordance with claim 52, the storing means comprising storage management engine comprising a front-end interface and an architecture which enables the implementation of plug-ins to interface with difference underlying database architectures.

57. A computer program comprising instructions to control a computing system to implement a method in accordance with claim 1.

58. A computer readable medium providing a computer program in accordance with claim 57.

59. A computer program comprising instructions for controlling a computer system to implement a method in accordance with claim 24.

60. A computer readable medium providing a computer program in accordance with claim 59.
